(19) United States
(12) Patent Application Publication
(10) Pub. No.: US 2011/0253603 A1
(43) Pub. Date: Oct. 20, 2011

(54) DEVICE FOR INSPECTING AND TRANSFERRING EGGS AND A METHOD APPLIED TO THIS END

(76) Inventor: Philip Karel Marie-Louise VAN DE LOO, Vianen (NL)

(21) Appl. No.: 13/085,607

(22) Filed: Apr. 13, 2011

(30) Foreign Application Priority Data
Apr. 15, 2010 (BE) 2010/0242

(51) Int. Cl. A01K 43/00

(52) U.S. Cl. 209/510

(57) ABSTRACT

Device (1) for inspecting and transferring eggs from a prehatching drawer (4) to a hatching tray (5), in which the device (1) contains two conveyor belts (2-3) that can respectively convey prehatching drawers (4) with prehatched eggs and empty hatching trays (5), whereby the device (1) contains an inspection unit (7) that has means to enable the prehatched eggs to be inspected, whereby the inspection unit (7) contains a transfer unit (8) to remove the rejected eggs from the prehatching drawer (4), whereby the device (1) contains at least one egg placement module (10-11) that can take all eggs out of a prehatching drawer (4) simultaneously and can separately place one or more of the eggs taken out.

The present invention relates to a device for inspecting and transferring eggs and a method applied to this end.

It is known that in poultry farms eggs are hatched in ‘incubators’.

The fertilised eggs are thereby placed in a prehatching drawer. The positioning of the prehatching drawer in the prehatching machine enables a large number of eggs to be prehatched in a limited small space under controlled conditions.

Depending on the type of poultry, after a certain number of days the prehatching drawers are taken from the prehatching machine and the eggs then have to be placed in ‘hatching trays’ in order to allow sufficient space for the hatching chicks.

It is known that the prehatched eggs in the prehatching drawer are inspected so that only the eggs that contain a viable embryo are placed in a hatching tray, after which the hatching tray is placed in an incubator.

In the known methods, an inspection transfer machine is used for this whereby the eggs are inspected in the prehatching drawer. If the egg contains a viable embryo, this machine will ensure that the egg is placed in a hatching tray.

However, the percentage of eggs that are rejected in the inspection transfer machine depends on the quality of the eggs and is thus not constant.

A disadvantage of the known machines is that the filling level of the hatching tray is not always optimum.

Indeed, if many eggs are rejected in the inspection transfer machine, the hatching tray will contain relatively few eggs and the percentage of chickens per unit volume in the incubator will be low, which leads to relatively high investment costs, operating costs, labour costs and a possibly disrupted hatching process.

In order to make more optimum use of the incubators, it is known that an operator carefully places eggs in the hatching tray when this hatching tray contains relatively few eggs.

A disadvantage is that the manual placing of the eggs is very labour intensive, as this has to be done very carefully to prevent damage to the eggs.

A disadvantage attached to this is that the manually placing of the eggs does not lead to a spectacular efficiency increase as there are additional labour costs and a higher risk of damage to the eggs.

Furthermore, complex inspection transfer machines are known that make use of a controllable robot arm that can take one egg or a few eggs from a separate prehatching drawer, and can place the eggs taken in the prehatching drawer, before all eggs in the prehatching drawer are placed in the hatching tray.

However, a disadvantage is that this robot arm has to perform many movements if the prehatching drawer contains a low number of eggs, which of course requires a lot of time such that the capacity remains low.

Another disadvantage is that if many eggs have to be placed, the prehatched eggs stay outside the incubators for too long, which also has a negative effect on the percentage of hatched chickens.

Such a complex arrangement is also disadvantageous from an economic point of view, on account of the high investment costs that are not offset by the efficiency increase realised.

The purpose of the present invention is to provide a solution to one or more of the aforementioned disadvantages and/or other disadvantages, by providing a device for inspecting and transferring eggs from a prehatching drawer to a hatching tray, in which the device contains two conveyor belts that respectively convey prehatching drawers with prehatched eggs and empty hatching trays, whereby the device contains an inspection unit that has means to enable the prehatched eggs to be inspected, whereby the inspection unit contains a transfer unit to remove the rejected eggs from the prehatching drawer and whereby the device contains at least one egg placement module that can take all eggs out of a prehatching drawer simultaneously and can separately place one or more of the eggs taken out.

The invention also concerns a method for inspecting and transferring eggs, whereby the method comprises the steps of conveying a prehatching drawer at least partially filled with prehatched eggs to an inspection unit one by one, the inspection of the eggs for the presence and/or viability of the embryo or chicken, and the removal of the rejected eggs from the prehatching drawer, taking all eggs out of a first prehatching drawer in an egg placement module, and placing one or more of the eggs taken out in a second prehatching drawer on the first conveyor belt or in a hatching tray on the second conveyor belt.

An advantage is that each hatching tray contains the desired number of prehatched eggs, which ultimately results in the optimisation of the number of chickens hatched per hatching tray.

An advantage attached to this is that savings can be made in many areas.

Indeed because all hatching trays are optimally filled, a smaller number of incubators is sufficient to hatch the same number of chickens, or in other words the number of hatched chickens per incubator increases.

Another advantage is that fewer hatching trays are required to hatch the same number of chickens, so that cleaning costs, energy costs, labour costs and buildings can be saved. In addition the separation of chickens and waste is done more efficiently.

The device is also indirectly beneficial with regard to the ultimate percentage of hatched chickens, as the risk is very low that there will be too few eggs in the hatching tray.

Another advantage attached to the optimum filling of the hatching tray is that the hatching process is not disrupted by places that are too warm and/or too cold.

An additional advantage is that the movements that the eggs can undergo are limited, such that the risk of damage to the eggs is greatly reduced.

In the most practical embodiment the device has two egg placement modules.

An advantage is that the efficiency can be increased even more.

Indeed, if there are too few eggs in the first egg placement module to reach the desired number of eggs in the prehatching drawer or hatching tray, then eggs can be placed in the prehatching drawer or hatching tray from the second egg placement module, so that this prehatching drawer or hatching tray, after having passed along both egg placement modules, contains the desired number of eggs.

As soon as one of the two egg placement modules contains no more eggs, the egg placement module can of course be filled with approved eggs from a new prehatching drawer.

Preferably the device has a control unit that records the length of time that the eggs are in the egg placement module, which determines how many eggs must be placed there in order to aim for the desired number of eggs in the hatching tray.

In the most practical embodiment of the invention, this aforementioned desired target number of hatching eggs can be set in the hatching tray.

In a practical embodiment with a number of egg placement modules, this control unit determines from which egg placement module or modules, one or more eggs have to be taken.

An advantage is that the eggs are in the egg placement module for a limited time, and in so doing the brooding and hatching process is not disturbed or barely disturbed, which of course contributes to a high hatching percentage of chickens.

In a first embodiment, the inspection unit has a transfer module that takes all approved eggs from the prehatching drawer and puts them in a hatching tray on the second conveyor belt.

In such an embodiment, prehatching drawers with eggs are first brought to the egg placement module and the eggs must be taken from the prehatching drawer on the first conveyor belt in the egg placement module and moved to a position above the second conveyor belt. The eggs are lowered according to the signals from the control unit into a hatching tray supplied by this conveyor belt.

In another more practical embodiment, the inspected approved eggs stay in the prehatching drawer, and the eggs from the egg placement modules are placed in this prehatching tray.

In this embodiment the prehatching drawer has the desired number of eggs and all these eggs are taken by a transfer unit downstream from the egg placement modules together and placed in a hatching tray on the second conveyor belt.

In the most practical embodiment, the device has egg placement modules and an egg detection module that records the empty positions in the prehatching drawer, and reports this to the control unit and/or the egg placement modules.

An advantage is that an egg can never be placed on top of another egg, not even when a rejected egg is left behind by accident when removing the rejected eggs.

With the intention of better showing the characteristics of the invention, a preferred embodiment is described hereinafter by way of an example, without any limiting nature, of a device according to the invention, with reference to the accompanying drawings, wherein:

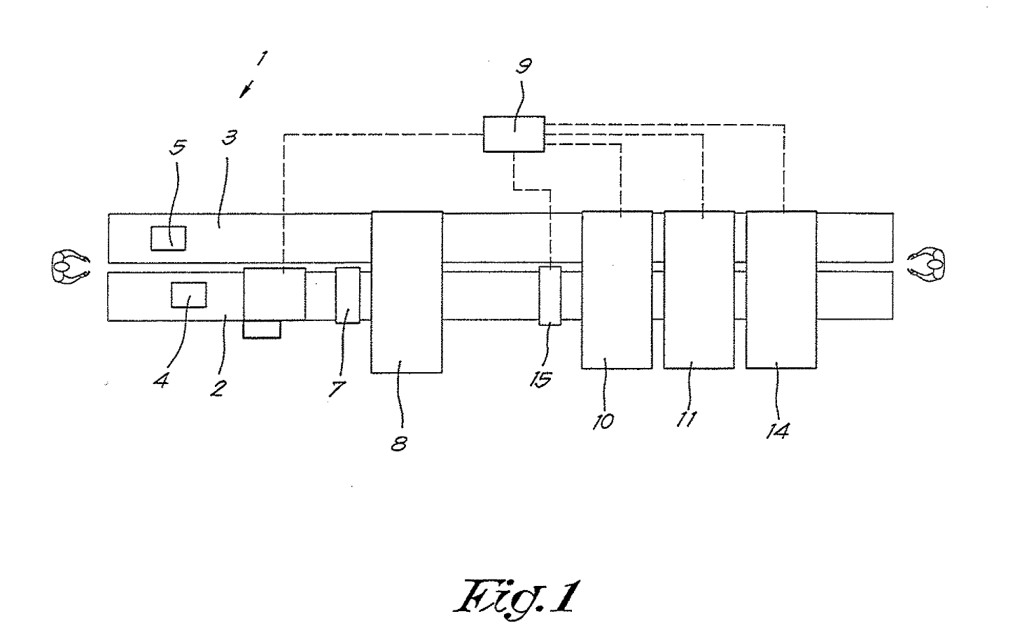

FIG. 1 schematically shows a top view of the most preferred embodiment of the device according to the invention.

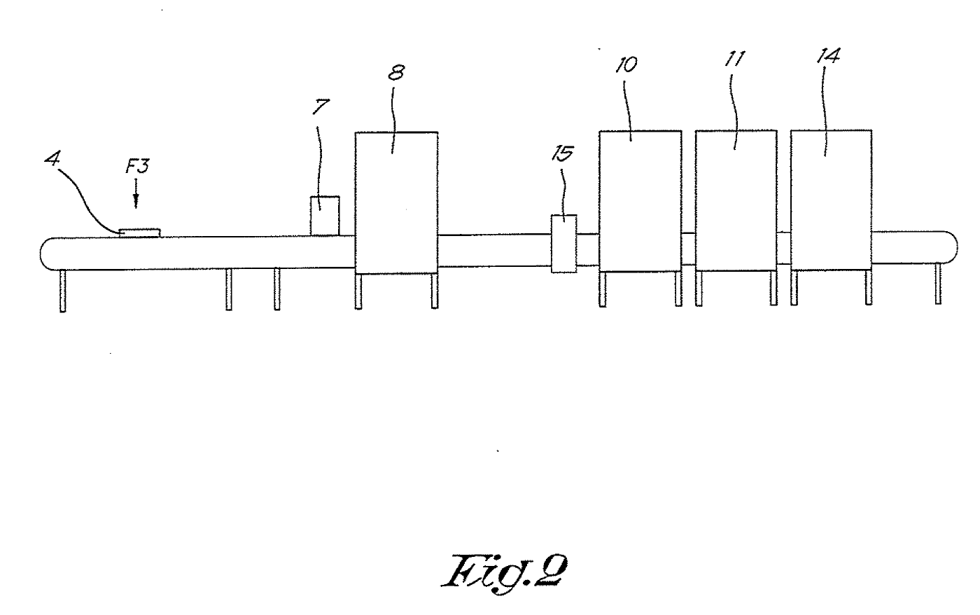

FIG. 2 schematically shows a side view of the device of FIG. 1.

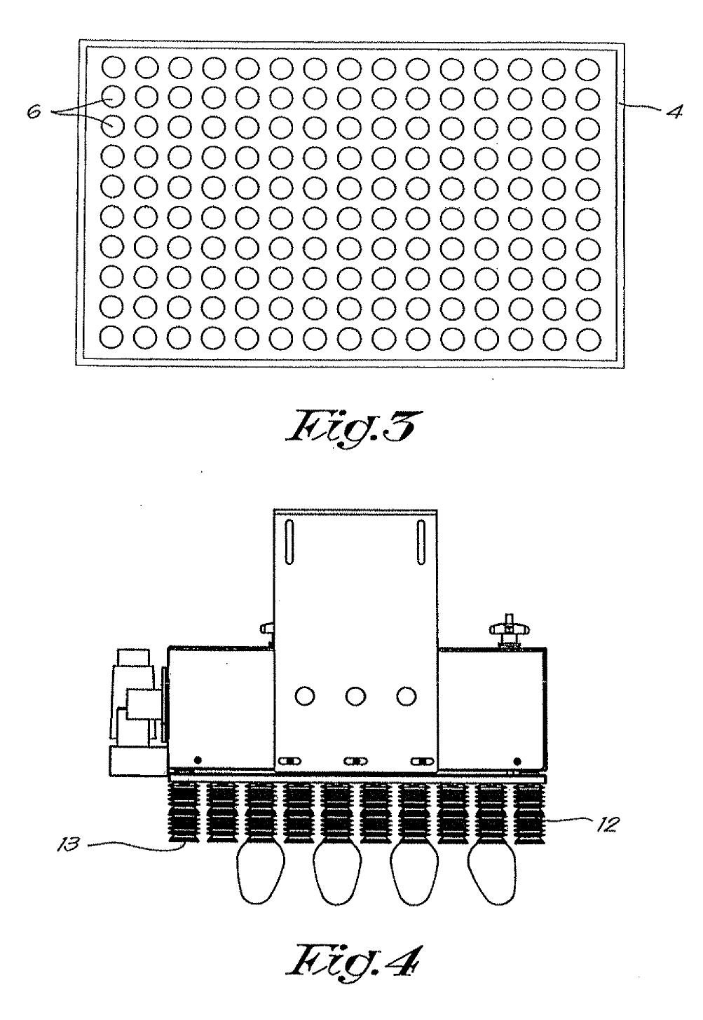

FIG. 3 shows a top view of the prehatching drawer according to the arrow F3 in FIG. 2.

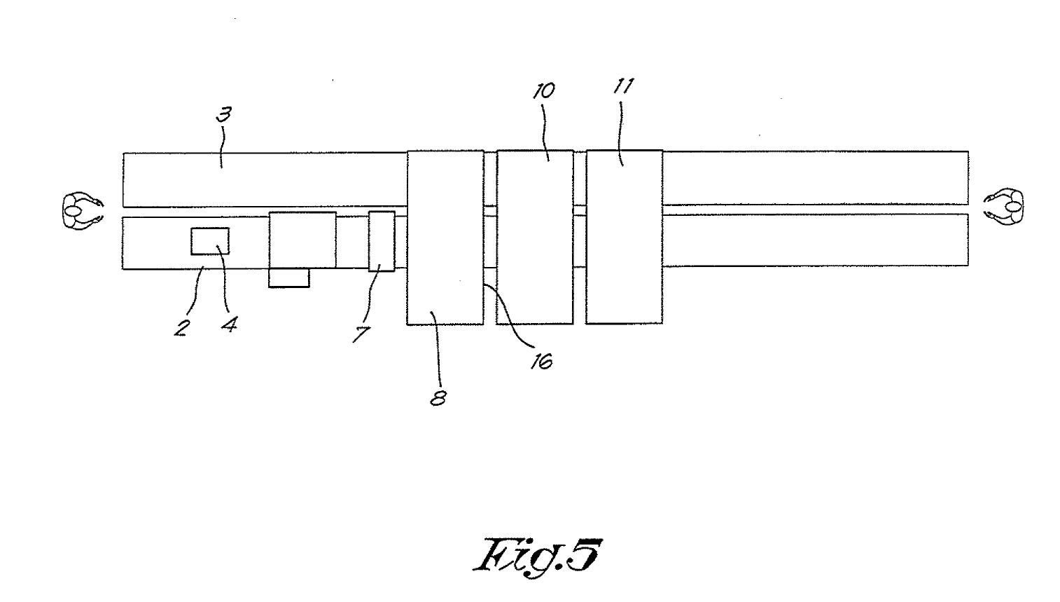

FIG. 4 shows a detail of the egg placement module.

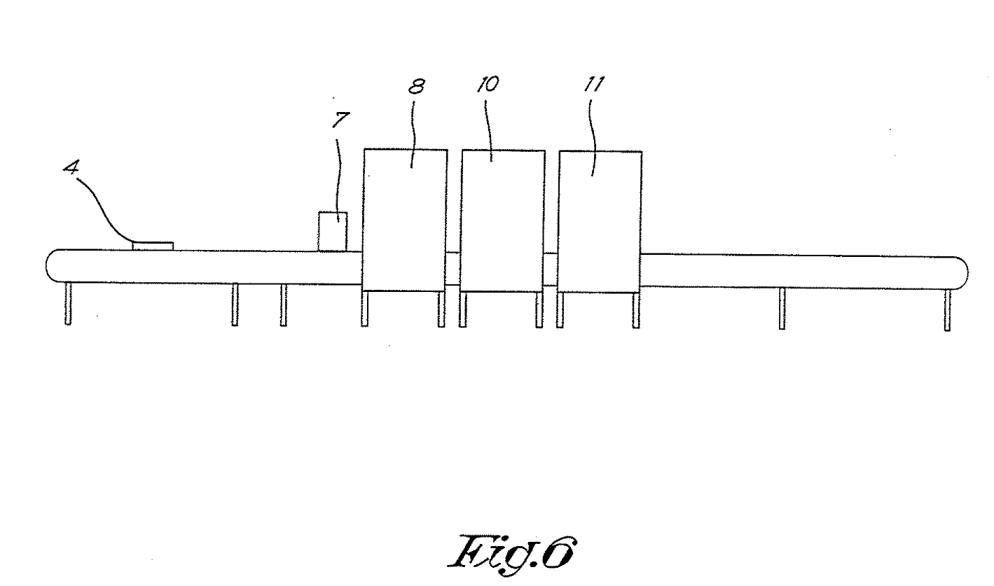

FIG. 5 shows a variant of FIG. 1.

FIG. 6 shows a side view of the variant of FIG. 5.

FIGS. 1 and 2 schematically show a device 1 for inspecting and transferring eggs that primarily consists of two conveyor belts 2-3, along which prehatching drawers 4 and hatching trays 5 respectively are transported.

Preferably each prehatching drawer 4 has a number of individual egg holders 6 and in each one there is a prehatched egg, as illustrated in FIG. 3.

In the most practical embodiment, these egg holders 6 are arranged in rows and/or columns with a fixed distance between them, for example in a grid of 10 rows and 15 columns, so that the prehatching drawer 4 can in this case contain up to 150 prehatched eggs.

The device 1 according to the invention further contains an inspection unit 7 that contains means for inspecting or testing the eggs.

Inspecting the eggs means examining whether an egg has been fertilised and/or whether the embryo is viable, which for example can be done by shining an inspection lamp on the egg.

In the inspection unit 7 one side of the egg can be illuminated and the other side can have a detector that measures the quantity of light transmitted through the egg and incident on the sensitive surface of the detector.

On the basis of the measured quantity of light, it can be determined whether the egg contains a viable embryo when this quantity is less than a certain percentage of the light transmitted by the inspection lamp.

In the embodiment shown, the inspection unit 7 contains a transfer unit 8 that takes the rejected eggs from the prehatching drawer 4 and moves these eggs in a sideways direction in order to place the rejected eggs next to the conveyor belt 2 or removes them via a waste chute provided for this purpose.

In a practical variant of the invention, the device 1 has a control unit 9 that receives data from the inspection unit 7 relating to the number and/or positions of the rejected or approved eggs.

According to the invention, in the device 1 there is at least one egg placement module 10 that can take out all eggs from the prehatching drawer 4 at the same time.

In the most preferred embodiment, there are a number of these egg placement modules 10-11, downstream from the inspection unit 7.

The egg placement module 10-11 can thereby be equipped with means to move the egg placement module 10-11 in a transverse direction over a distance that is at least equal to the aforementioned distance between the egg holders 6. The aforementioned means can also move the eggs in a vertical direction.

The egg placement module 10-11 preferably has a series of suction cups 12 for picking up and placing the eggs, as shown in FIG. 4.

The aforementioned suction cups 12 are arranged in a regular pattern, preferably in a pattern of rows and columns with a distance between them that corresponds to the distance between the egg holders 6 in the prehatching drawer 4.

Each suction cup 12 can be made of a flexible housing 13 with a length that is variable, and preferably each suction cup 12 is separately connected to a vacuum system so that the air pressure in the space within the suction cup 12 is kept below atmospheric pressure.

In a practical embodiment, the vacuum system contains at least one vacuum chamber, whereby each suction cup 12 is connected to this vacuum chamber via one pipe that can be closed by a valve, and which can again be opened by the valve, depending on the desired action, in order to pick up or release an egg.

In the aforementioned control unit 9, there can be means to activate or deactivate the aforementioned valves.

In a practical variant of the invention, the device 1 has a transfer unit 14 that is downstream from the egg placement modules 10-11.

As this transfer unit 14 picks up and moves the approved eggs, specific measures are preferably taken to avoid damage to the eggs in this transfer unit 14.

In a practical embodiment, the transfer unit 14 also has a vacuum system with suction cups 12, somewhat similar to the pickup system of the egg placement modules 10-11.

However, the pickup system of the transfer unit 14 can be constructed much more simply because, in contrast to the pickup system in the egg placement modules one single central valve for all suction cups is sufficient. After all, all eggs are always picked up and put down in the transfer unit 14.

Although not strictly necessary for the invention, the device 1 in FIGS. 1-2 have an egg detection unit 15 that scans the prehatching drawer 4 and reports the empty and/or filled positions in the prehatching drawer 4 to the control unit 9.

Of course these data can also be sent by the inspection unit 7 to the control unit 9, and enable the data of the egg detection unit 15 to verify the data of the inspection unit 7.

In a practical embodiment, the control unit 9 can be provided with a touchscreen, a keyboard or similar, such that the user can enter the number of eggs that have to be put in the hatching tray 5.

In addition, the control unit 9 can have a memory module or similar in order to collect data relating to the quantity and quality of the eggs from the prehatching drawers 4 or similar.

The method for inspecting and transferring eggs on the basis of the device 1 is very simple and as follows.

The prehatching drawers 4 are supplied via the first conveyor belt 2 and are at least partially filled with prehatched eggs. These prehatching drawers 4 are transported to the inspection unit 7 where they are inspected or tested.

The rejected eggs are removed in the transfer unit 8 of the inspection unit 7 from the prehatching drawer.

It is possible that the rejected eggs picked up are moved sideways and from there removed, by placing these eggs on a conveyor belt, for example, or throwing them in a chute.

Irrespective of the chosen method, in principle the prehatching drawer 4 only contains approved eggs after passing through the inspection and transfer unit 7-8.

Then this first prehatching drawer 4 with approved eggs is moved to a first egg placement module 10. In this egg placement module 10, the eggs are taken out of the prehatching drawer 4 by means of a vacuum system and suction cups 12, and held above the first conveyor belt 2.

The suction cups 12 are hereby placed against the eggs, and the eggs are carefully sucked up.

Then the emptied first prehatching drawer 4 can be removed by the first conveyor belt 2.

A second prehatching drawer 4 that is also supplied by the first conveyor belt 2 goes through similar steps, albeit that the second prehatching drawer 4 with approved eggs is moved to the second egg placement module 11. In this second egg placement module 11 too, the eggs are picked up and held above the first conveyor belt 2, and the empty prehatching drawer is then taken away by the first conveyor belt 2.

A third prehatching drawer 4 supplied by the first conveyor belt 2 also goes through the steps of inspection and removal of the rejected eggs.

On the basis of the number of approved eggs in the third prehatching drawer 4 and the desired number of eggs in the hatching tray 5, the control unit 9 can calculate whether there are already sufficient eggs in the prehatching drawer 4 or whether eggs still have to be added.

When this third prehatching drawer 4 passes through the egg detection unit 15, the drawer 4 will be scanned and the empty and/or filled positions will be reported to the control unit 9.

After all, from the inspection of the first and second prehatching drawers 4, the positions of the approved eggs in the egg placement modules 10-11 are known.

On the basis of the empty positions in the third prehatching drawer 4 and the positions of the eggs in the egg placement modules 10-11, the control unit 9 will determine the number of additional eggs that have to be placed and also how many eggs from which egg placement module 10-11 have to be used for this purpose.

Preferably the algorithm in the control unit 9 not only takes into account the positions of the eggs in the egg placement modules 10-11, in order to limit the number of sideways movements as much as possible, but also the period of time in which the eggs are in the egg placement module 10-11.

When the third prehatching drawer 4 is supplied by the first conveyor belt 2 under the first egg placement module 10, a number of picked-up eggs will be lowered into the empty egg holders 6 of the prehatching drawer 4.

Because the prehatching drawer 4 is slid slowly under the egg placement module 10, it is possible to place any egg at random in a certain row of the egg placement module 10 in any arbitrary empty position of the same row of the prehatching drawer 4.

It is possible that that the egg placement module 10 makes a movement in the transverse direction in order to move an egg that is initially above a filled egg holder 6 to a position above an empty egg holder 6 in the third prehatching drawer 4, whereby the movement in the transverse direction moves the egg from one row to another.

As a result of the vacuum system, it is possible for the egg or eggs to be lowered in a controlled way so that the eggs are not damaged.

It is also possible that the control unit 9 brings the prehatching drawer 4 directly under the second egg placement module 11, if it follows from the algorithm that the prehatching drawer 4 only has to be filled with eggs from the second egg placement module 11, or if these eggs have already been in the egg placement module 11 for a long time.

After placing one or more eggs from the first and/or second egg placement module 10-11 or otherwise, the third prehatching drawer 4 is brought to below the transfer unit 14.

At the location of the transfer unit 14, the third prehatching drawer 4 will contain the desired number of eggs. This target value corresponds to the ideal number of eggs that are desired to be placed in the hatching tray 5.

The eggs are picked up via the transfer unit 14 from the prehatching drawer 4 and moved in a transverse direction to the second conveyor belt 3, on which an empty hatching tray 5 is transported.

After the eggs have been placed in the hatching tray 5 via the transfer unit 14, the filled hatching tray 5 is removed by the second conveyor belt 3 and taken to the incubator, and the emptied third prehatching drawer 4 is removed by the first conveyor belt 2.

It is clear to a man skilled in the art that if the third prehatching drawer 4 already holds enough approved eggs, the placing of additional eggs from the egg placement modules 10-11 is completely superfluous and even undesired, and in that case the prehatching drawer 4 can proceed without interim stops in the egg placement modules 10-11 to the transfer unit 14.

If both egg placement modules 10-11 still contain eggs, after, the third prehatching drawer 4 a fourth prehatching drawer 4 is supplied and filled.

As soon as one of the two egg placement modules 10-11 has no more eggs, the control unit 9 will ensure that a prehatching drawer 9 with approved eggs is again taken to the egg placement module 10-11 concerned.

In the most practical variant of the invention, the priority for placing the eggs is determined, among others, by the length of time that the eggs have been in the egg placement module 10-11. When this duration threatens to exceed a certain limit, the priority for placing the egg can be increased considerably.

Although the algorithm in the control unit 9 is aimed at the eggs having to be placed within a prior maximum time limit, in exceptional cases it may happen that the eggs stay in the egg placement module 10-11 for too long, for example when many successively supplied prehatching drawers 4 contain enough eggs.

If the maximum time duration is exceeded, the control unit 9 can send a signal to the egg placement module 10-11, and it can evacuate the eggs or the egg by making a sideways movement for example and removing the eggs via a separate conveyor belt or waste chute.

It may be that when the maximum duration is exceeded, an optical or acoustic signal is generated.

However, it is clear that the algorithm of the control unit is programmed to minimise the number of eggs that stay in the egg placement module for too long. FIGS. 5 and 6 show a second variant of the invention that mainly differs from the first one by the absence of the transfer unit 14 after the egg placement modules 10-11, and by the characteristic that the egg placement modules 10-11 pick up the eggs and move them to a position above the second conveyor belt.

In this embodiment, the egg placement modules 10-11 will be kept at a certain height above the second conveyor belt 3 so that a hatching tray 5 supplied by the conveyor belt 3 cannot accidentally hit the eggs.

Although FIGS. 5 and 6 show two egg placement modules, it is of course possible that the device only contains one egg placement module or that the device contains more than two egg placement modules.

In a variant not shown, the inspection unit 7 can have two separate transfer units 8-16, whereby a first transfer unit 8 removes the rejected eggs and the second transfer unit 16 picks up the approved eggs from the prehatching drawer 4 and moves them in the transverse direction to above the second conveyor belt 3.

In the variant shown there is one transfer unit that first removes the rejected eggs, and then picks up and moves the remaining approved eggs.

The method for inspection and transferring is similar.

In the first instance one or two prehatching drawers 9 are inspected and taken to an egg placement module 10-11, where the eggs are picked up and moved in a transverse direction so that they come to the second conveyor belt 3.

Empty hatching trays 5 are supplied by the second conveyor belt 3, and at the level of the inspection unit 7 the approved eggs of the third prehatching drawer supplied will be placed in a hatching tray 5 by the transfer unit 16, whereby the valve of the suction cup concerned or the suction cup itself has a calibrated passage so that the underpressure is only gradually removed and tends towards atmospheric pressure.

If the number of eggs in the hatching tray 5 is less than the ideal number, the control unit 9 calculates how many eggs have to be added to the hatching tray 5.

If the device contains two egg placement modules 10-11, it also determines which egg placement module 10-11 the hatching tray 5 must be positioned by, and how many eggs must be added to the hatching tray 5 by each egg placement module 10-11.

In this embodiment, account is also taken of the fact that the eggs must not stay in the egg placement module 10-11 for too long.

If the egg placement module 10-11 has to place one or more eggs in the hatching tray 5, the underpressure is removed in the suction cup concerned, all such that the egg can descend relatively slowly and be carefully placed in the hatching tray, whereby to this end the valve of the suction cup concerned or the suction cup itself has a calibrated passage so that the underpressure is only gradually removed.

If an egg is placed in a position in the hatching tray 5 that is not empty, the flexibility of the suction cup 12, together with the force of gravity, will ensure that the egg to be positioned looks for a way between the eggs already present in the hatching tray 5, without the eggs being damaged by this.

In this way, after passing through one or two egg placement modules 10-11, the hatching tray will contain the set number of eggs and the first conveyor belt 2 will remove the empty prehatching drawers 4, while the second conveyor belt 3 removes the filled hatching trays 5.

Although the embodiments of the drawings suggest a manual positioning and removal of prehatching drawers 4 and hatching trays 5, it is not excluded that the prehatching drawers 4 and/or hatching trays 5 are placed or removed on the conveyor belts 2-3 concerned automatically.

Although in the foregoing description, conveyor belts are always mentioned for the supply and removal of prehatching drawers and hatching trays, it is clear that these conveyor belts can be replaced by alternative transport systems, for example in the form of continuous plastic chains in a circuit.

The present invention is by no means limited to the embodiments described as an example and shown in the drawings, but a device according to the invention for inspecting and transferring eggs and the method applied to it can be realised in all kinds of variants, without departing from the scope of the invention.

1-17. (canceled)

18. Device for inspecting and transferring eggs from a prehatching drawer to a hatching tray, comprising:
two conveyor belts arranged to respectively convey prehatching drawers with prehatched eggs and empty hatching trays;
an inspection unit for inspecting the prehatched eggs comprising a transfer unit arranged to remove rejected eggs from the prehatching drawers; and
at least one egg placement module arranged to take all eggs out of a prehatching drawer simultaneously and to separately place one or more of the eggs taken out.

19. Device according to claim 18, including one or more egg placement modules that are located downstream from the inspection unit.

20. Device according to claim 18, including a control unit that records the time for which an egg is in an egg placement module and that determines the priority for placing the eggs by taking said time into account, and that, when a time limit is exceeded, evacuates the egg and/or gives an acoustic signal and/or an optical signal.

21. Device according to claim 18, wherein between the inspection unit and a first egg placement module there is located an egg detection unit.

22. Device according to claim 18, wherein the egg placement module comprises a series of suction cups arranged to pick up and position the eggs, each suction cup being separately connected to a vacuum system arranged to apply an underpressure in the space within the suction cup.

23. Device according to claim 22, wherein the vacuum system comprises at least one vacuum chamber to which the suction cups are each connected separately via a pipe that is closeable by a valve.

24. Device according to claim 22, wherein each suction cup comprises a flexible housing with a variable length.

25. Device according to claim 22, including a control unit arranged to activate and deactivate the valves.

26. Device according to claim 18, wherein the inspection unit comprises a transfer unit arranged to pick up inspected eggs from the prehatching drawer and to place the eggs picked up in a hatching tray on the second conveyor belt.

27. Device according to claim 18, wherein the control unit includes an algorithm arranged to move the eggs picked up in the egg placement module to a position above the second conveyor belt.

28. Device according to claim 18, including a transfer unit arranged to pick up and to position all eggs from the prehatching drawer in a hatching tray.

29. Device according to claim 28, wherein the transfer unit is placed downstream from the egg placement module.

30. Device according to claim 28, wherein the prehatching drawer includes individual egg holders that are positioned in rows and/or columns with a fixed distance between them, and the egg placement module includes a means to move the egg placement module in a transverse direction over a distance that is at least equal to the aforementioned distance between the rows and/or columns.

31. Method for inspecting and transferring eggs, comprising the steps:
conveying prehatching drawers at least partially filled with prehatched eggs to an inspection unit one by one;
inspecting the eggs for the presence and/or viability of the embryo or chicken, and removing rejected eggs from the respective prehatching drawer; and
taking all eggs out of a first prehatching drawer in an egg placement module and placing one or more of the eggs taken out in a second prehatching drawer on the first conveyor belt or in a hatching tray on the second conveyor belt.

32. Method according to claim 31, wherein the number of eggs to be placed depends on the number of rejected and/or approved inspected eggs of the prehatching drawer.

33. Method according to claim 31, wherein the number of eggs to be placed depends on a target value.

34. Method according to claim 33, wherein the target value is set beforehand, or is set or adjusted by the user via a control unit.
